(19) United States
(12) Patent Application Publication
(10) Pub. No.: US 2006/0059251 A1
(43) Pub. Date: Mar. 16, 2006

(54) Method and system for request management processing

(76) Inventors: Gary D. Cunha, Medway, MA (US); Dino M. DiBiaso, Natick, MA (US); Richard T. Berthold, Ashland, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/136,609

(22) Filed: May 1, 2002

(51) Int. Cl. G06F 15/173

(52) U.S. Cl. 709/223

(57) ABSTRACT

A system and method are provided for determining a processing engine to process a request from a client in a distributed client-server architecture. Requests from the clients are handled by a request management module, which determines a processing entity for each request. A processing entity may be one or more processing engines, or one or more additional request management modules in conjunction with additional processing engines. Processing entities register with the request management module as available to process the requests. Processing entities may be determined based on the information supplied in the requests, such as, for example, required characteristics of the processing entities. Once the processing entity is determined, the request is transferred to that processing entity, where the request is processed. Results of processing the request are transferred to the original request management module, from where they are transferred back to the requesting client. During the transfer to or from the request management module, requests and their results may be parsed or normalized. Alternatively, requests and results may be converted into different representations.

### FIELD OF THE INVENTION

This invention relates to techniques for managing the use of processor resources for executing processing requests in systems (particularly client-server systems) having multiple processors potentially available to process a given request. More particularly, the invention relates to determining a processing engine for processing a particular request and allows for processing engines to enter and leave the system from time to time.

### BACKGROUND OF THE INVENTION

Client-server architecture is widely used in the computer industry to perform various tasks requested by clients. Typically, a client sends a request to a server, often referred to as an engine, where the request is processed and results of the processing are sent back to the client. Client-server architecture may be embodied in hardware and software, or may be purely logical; requests and results may be communicated over a network, internal busses or a combination thereof, correspondingly.

In a typical client-server arrangement, there are many more clients than servers. Frequently, a single server receives all the requests and performs all or most of the computation for the clients. While it is convenient for clients to have a single access point to the server(s) (called a “request manager” herein) such an arrangement may be prone to frequent downtimes for server upgrades or maintenance or when a number of requests exceeds server computation capacity.

Prior art systems have used multiple completely redundant servers with a single access point to reduce downtime and server overloading. In such an arrangement, a single server (functioning as a request manager) receives all requests and forwards them to other servers for processing. Forwarding is typically done based on a rudimentary arbitration scheme, such as, for example, choosing a server to process a request at random or in a round-robin fashion. Such systems traditionally do not parse or pre-process requests before forwarding them to processing servers. Furthermore, servers typically need to be identically configured in order to provide consistent results. Configuring servers identically allows servers to be interchangeable, which means that multiple requests from one client may be handled by multiple servers without the client being aware of it. While that is beneficial to the client, it may mean that all servers need to be equipped with extensive hardware support or additional software modules that may be needed only for a small percentage of the requests.

In a number of prior art systems, servers do not send results of the processing back to the clients through the same channel as they receive requests; instead, results are often sent back directly to the clients. Furthermore, in several prior art systems, further communication between the client and the server usually takes place directly, without involving the request manager(s). Such systems are called “peer-to-peer” systems. Peer-to-peer systems do not require servers to be identically configured—in fact, they may be specifically created such that different servers contain different resources and requests may be routed based on the available and require resources. However, in such an architecture, performance offered to a client may suffer if the server with which it is interacting becomes unavailable during the transaction, especially if the transaction as a whole involves two or more processing requests. Such a failure would be less likely in a system with the single access point and multiple servers processing the request.

Therefore, there is a need for a distributed client-server architecture that will allow different servers to fulfill client requests while providing clients with a single access point and seamless interface in which the clients need not be dependent on a particular server.

### SUMMARY OF THE INVENTION

A system and method are provided for determining a processing engine to process a request from a client in a distributed client-server architecture. Requests from the clients are handled by a request management module, which determines a processing entity for each request. A processing entity may be one or more processing engines, or one or more additional request management modules in conjunction with additional processing engines. Processing entities may be determined based on the information supplied in the requests, such as, for example, required characteristics of the processing entities. Once the processing entity is determined, the request is transferred to that processing entity, where the request is processed. Results of processing the request are transferred to the original request management module, from where they are transferred back to the requesting client. During the transfer to or from the request management module, requests and their results may be parsed and/or normalized. Alternatively, requests and results may be converted into different representations.

According to one aspect of the invention, a method is provided for processing a request in a distributed client-server system. The method comprises acts of registering available processing entities with the request management module, receiving the request at the request management module, determining a processing entity to process the request and forwarding the request to that processing entity. The processing entity may process the request and transfer the results of the processing back to the request management module; from there the results may be transferred back to the originating client.

According to another aspect of the invention, the processing entity may be determined based on the information in the request and information about available processing entities that is stored in the request managing module. The information about the available processing entities may generally comprise information about location (both network and physical) and processing capabilities of the entities. In addition, the information about the available processing entities may comprise thematic information, such as information about access control or modules or hardware available to process client requests. There may be more than one processing entity that match characteristics requested by the client. In such a case, the processing entity to process the request may be determined using any arbitration scheme known in the art. Taken into account may be such parameters as proximity (both network and physical) between the client and the processing entities, urgency of the request, processing capacity of the entities, etc.

According to yet another aspect of the invention, request management modules may be arranged hierarchically, processing requests from multiple clients and redirecting them to multiple processing engines. Each processing engine may register with one or more request management modules. For example, a particular processing engine may register with a default request management module if such is available, and register with other request management modules when the default one is not available.

According to yet another aspect of the invention, the request may be normalized prior to being received by the processing entity. Such normalization may involve converting the request from a representation in one protocol to a representation in another protocol. Furthermore, the results of the request may also be converted from one representation to another prior to being transferred back to the originating client.

According to yet another aspect of the invention, there is provided a computer-readable medium storing instructions, that, when executed on appropriate computer hardware, direct the execution of the methods of the invention as described above.

According to yet another aspect of the invention, a system is provided for determining the processing entity to process a particular request from the client. The system comprises at least two processing entities, a request management module, and clients sending the requests. The request management module may store information about the available processing entities, such as, for example, information about their location and processing capabilities, and the requests may be routed based on a match between information in the requests and the information about the available processing entities.

According to yet another embodiment of the system, a processing engine is provided for use in the distributed system processing the requests from the clients. The processing engine may register with the request management module as available to receive and process the requests from the clients.

### BRIEF DESCRIPTION OF THE DRAWINGS

FIG. 1 is a schematic representation of the system of one embodiment according to the invention;

FIG. 2 is a schematic representation of the request management module;

FIG. 3 is a flow chart illustrating processing engine registration at the request management module;

FIG. 4 is a schematic representation of a table of available processing engines;

FIG. 5 is a flow chart illustrating processing engine registration performed at a processing engine;

FIG. 6 is a flow chart illustration determining an engine to process the request;

FIG. 7 is a flow chart illustrating processing the request;

FIG. 8 is a schematic representation of client user interface.

### DETAILED DESCRIPTION

The following detailed description should be read in conjunction with the attached drawings in which similar reference numbers indicate similar structures. One embodiment is illustrated of a client-server system for processing requests from clients on servers, although numerous other systems may be implemented according to the aspects of the invention. The embodiment described herein may be modified and adapted for a number of tasks as deemed appropriate by one skilled in the art.

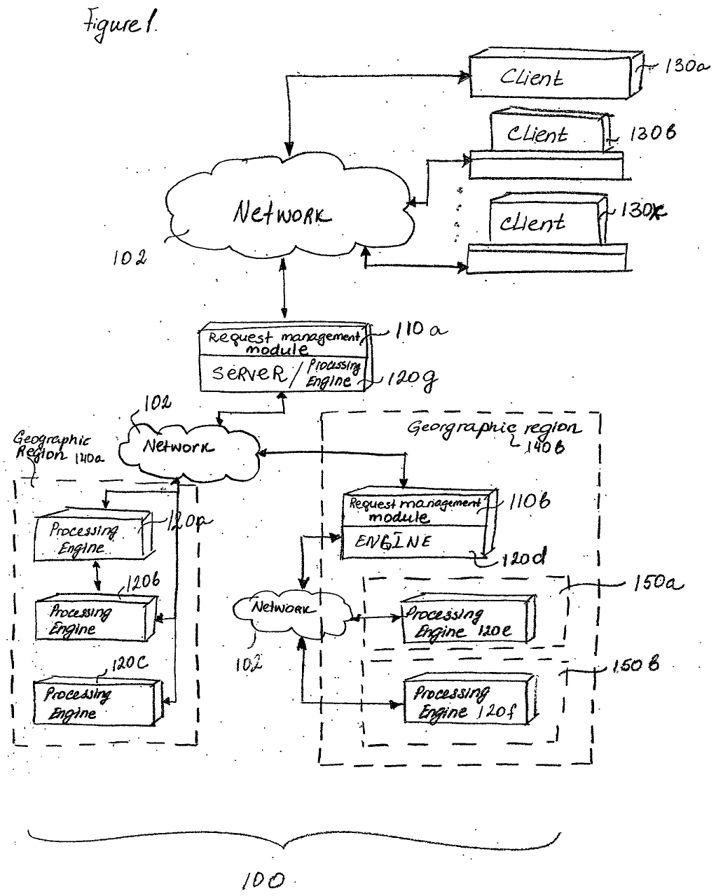

FIG. 1 is a diagrammatic representation of an illustrative system 100 according to one embodiment of some aspects of the invention. System 100 may be implemented as a client-server architecture, where clients and servers interact to perform tasks. Clients 130 are said to send “requests” to servers. Requests generally are tasks to be processed on one or more of engines 150. We refer to “servers” and “engines” interchengeably herein. The term “engine” may be used to describe any program, software module, hardware module, or a combination thereof, that is capable of processing requests from clients. Any kind of engine known in the art may be used, as appropriate for a particular application. For example, engines may be web servers, remote-procedure-call (RPC) servers, or Enterprise Control Engines, described in application U.S. Ser. No. 09/418,942, filed Oct. 15, 1999, and title ENTERPRISE LEVEL INTEGRATION AND COMMUNICATION TECHNIQUES which is incorporated herein by reference in its entirety.

Requests may comprise requests for an engine to perform a computation, access or search a particular information storage element or system, perform a hardware check, or to perform any other function as determined by one skilled in the art. An engine may be connected to one or more physical communication networks. For example, an engine may be connected to a telephony network, and a request from a client may call for a check on the status of one of the areas of the telephony network. Processing results for such a request may include obtaining status updates and computing statistics associated with checking the telephony network.

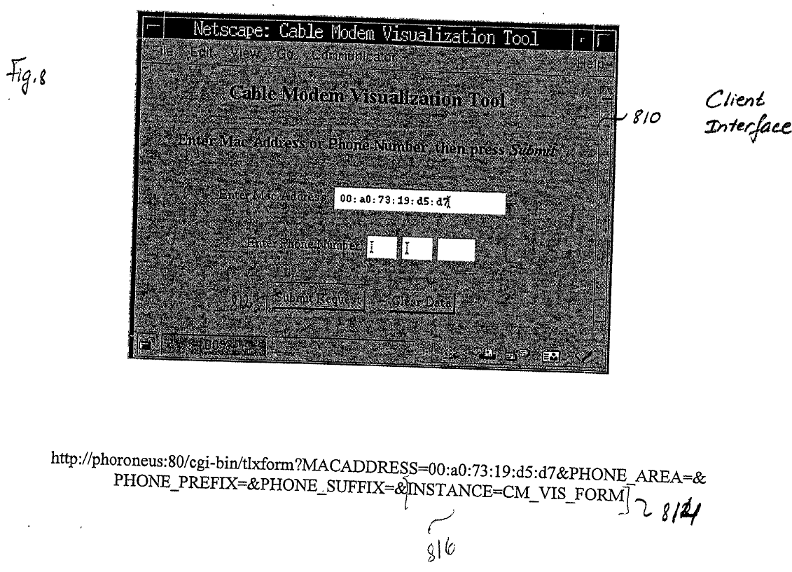

Each of clients 130 (e.g., 130a-130c, which are representative of an arbitrary number of clients) may be a stand-alone software application or may be implemented as a part of other software programs. A user interface for the client (see FIG. 8) may be implemented in any convenient form, such as an HTML form in a web browser. Clients may be platform-independent or may be directed to a particular platform, as determined by one skilled in the art.

Clients 130 may be connected to network 102 through which they may access a request management module 110a. Network 102 may be the global Internet, a Local Area Network (LAN), an intranet or any other kind of a specialized or general-purpose network (or combination thereof) allowing for communications between clients 130 and request management modules 110.

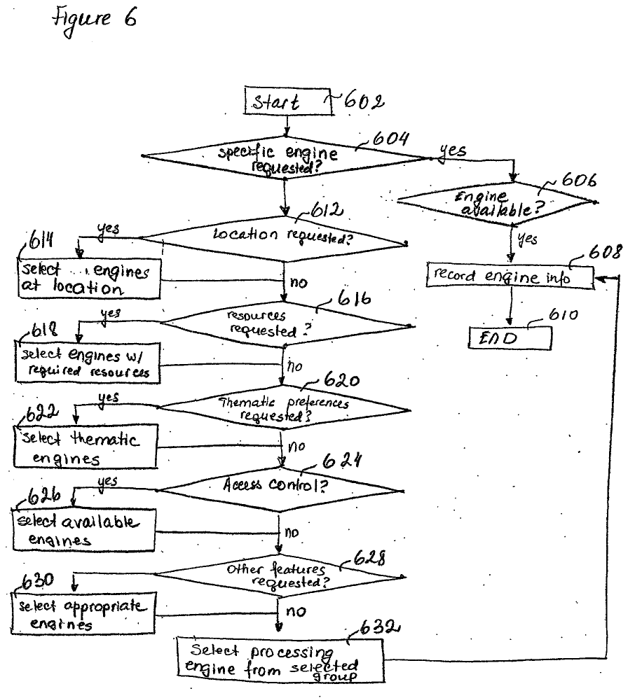

Request management modules 110a receives requests from clients and determine(s) one or more processing engines 120 to process the requests. Such a determination may be made on the basis of the content or nature of the request itself, such as, for example, computational resources required to process the request, hardware resources requested, or access to particular databases required. Determination of the processing engine(s) to process a particular request is described in further detail in connection with FIG. 6.

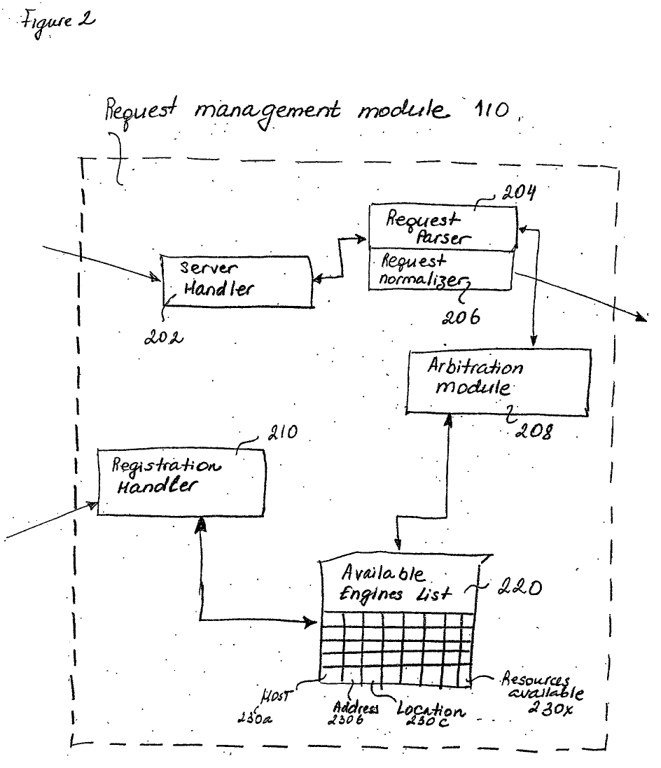

Request management module 110a may be a software program or a module, a hardware module, or a combination thereof. Request management module 110a, for example, may be physically located on a server, which server may in turn be a processing engine. Request management module 120 is described in further detail in connection with FIG. 2.

A particular client may choose to connect to a single request management module, such as, for example, request management module 110. Client 130a may connect to two or more request management modules, such as, for example, to request management modules 110a and 110b. Client 130a may also use request management module 110a as the default access point and connect to an alternative request management module only if request management module 110a is unavailable.

Communication between clients 130 and request management modules 110 may be accomplished by any means known in the art. It may be a connectionless communication, or communication according to a connection-based protocol. For example, client 130a may communicate with request management module 110a using a HyperText Transfer Protocol (HTTP).

Request management module 110a may be connected to processing engines 120 and other request management modules 110b-x (“x” being the indication for the last of the modules) through network 102. It may be a private network, or a part of the global network 102, as appropriate for a particular implementation of the invention. In another embodiment of the invention, request management module 110a may be a software module located on a computer that also houses processing engine 120a.

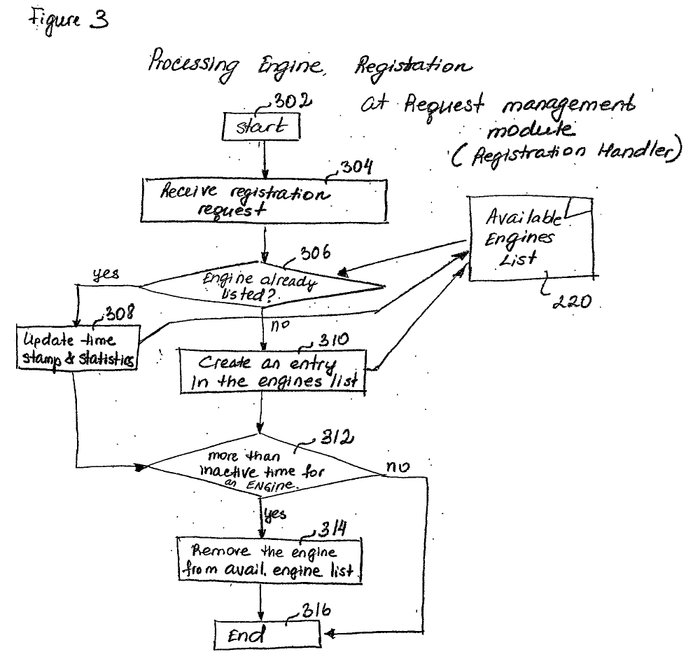

In general, unless context indicates otherwise, when used herein, the word “connected” means operatively interconnected, directly or indirectly via one or more intervening elements. Request management module 110a may be connected to one or more request management modules 110b-x and may send requests to those modules. Requests may be redirected to other request management modules based on the information in the requests or requirements of the clients. Requests may also be redirected to other request management modules when request management module 110a does not have capacity to process all the requests. There may be a hierarchy of request management modules 110 receiving requests from the clients and determining processing engines 120 or other request management modules to further process or act on the request. Request processing is described in further detail in conjunction with FIGS. 3, 4, and 7.

Two or more processing engines may act in concert to process a particular request. In various embodiments, from a point of view of the request manager module it may make no difference whether requests are being routed to a single processing engine, to a number of engines acting in concert, or to another request manager module that will route the requests to the different processing engines. A term “processing entity” is used herein to refer to an entity that receives a request in order to process it; such a processing entity may comprise a single processing engine, multiple processing engines, or one or more request manager modules and one or more processing engines.

Processing engines 120 may register with request management module 110a as available to process requests. Such registration may be accomplished through a processing engine handler (see FIG. 2) in the request management module. In some embodiments of the invention, only registered processing engines may receive requests for processing. In other embodiments of the invention, registration of processing engines may be used in conjunction with other approaches known in the art for locating processing engines. Registration and re-registration of processing engines are further described in connection with FIGS. 3-6.

Processing engines may be physically located in one or different geographic or logical regions. For example, processing engines 120a-c may be located in geographic region 140a which may be distinct from geographic region 140b containing request management module 110b and processing engines 120d-f. Physical location of the processing engines may be used in determining a processing engine to process a particular request. Alternatively, logical “regions”, such as, for example, regions 150a and 150b may be used to represent clusters of processing engines. Such clusters may be, for example, identically configured, or have similar access restrictions. In some embodiments of the invention, logical subdivision may be accomplished according to a redundancy scheme, as known in the art.

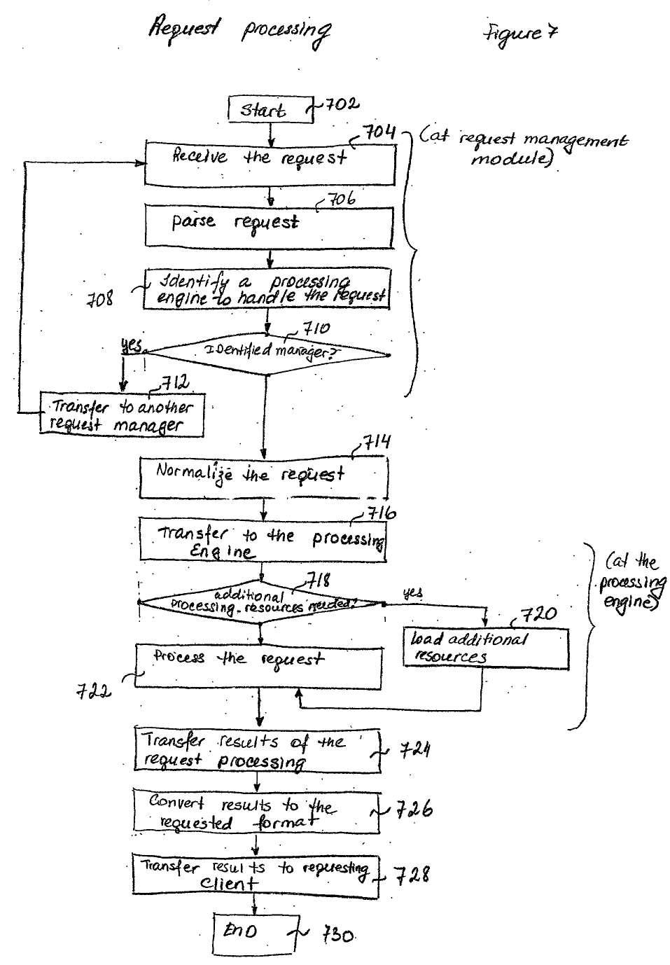

Processing engines 120 may be connected to each other in various ways, such as by a network(s) 102 or by local busses or a combination thereof. Different processing engines 120 may be configured differently, such that they may have access to different hardware and software modules. Alternatively and/or additionally, different processing engines 120 may have capabilities for loading different software modules in response to a request, or may provide processing only to requests from a particular set of clients. For example, processing engine 120a may have access to telephony and cable modem networks (not shown) and may process requests that require providing status updates on those additional networks. Request processing is described in further detail in connection with FIG. 7.

In processing the requests, processing engines 120 may require resources available to other processing engines. In order to access those resources, they may send requests and thus act as clients in system 100. Such requests may be routed by request management modules 110 as regular requests.

Note that the distinction between a “client” and a “server” is purely logical, and the same hardware or software module may perform either one or both of those tasks according to circumstances or at different times. For example, processing engine 120e may send a request to request management module 10a in order to receive a status update on a telephony network (not shown). Such information may be provided, for example, only by processing engines in region 140a.

In some embodiments of the invention, a processing engine may be registered at more than one request management module 110 and may process requests redirected by those request processing modules. In yet another embodiment of the invention, a processing engine may process multiple requests concurrently.

FIG. 2 diagrammatically illustrates request management module 110. Request management module 110 may include one or more modules dedicated to particular functions. Such modules may be software functions, programs, or objects, as determined by one skilled in the art, and processor compartments to execute them.

Server handler 202 may provide server functions for receiving requests from clients. For example, if clients communicate with request management module 110 using HTTP, server handler 202 may support and service the HTTP communications. A request may proceed from the server handler into request parser 204. Request parser 204 preferably performs a preliminary parsing of the request. Such parsing, for example, may identify which client submitted the request, what kind of computations are being requested, and any characteristics of the processing engines that are requested by the client.

Results of parsing of the request may be used by arbitration module 208 to determine a processing entity to process the request. In some embodiments, minimal or no parsing may be performed and the processing entity may be determined on the basis of processing entities' characteristics alone.

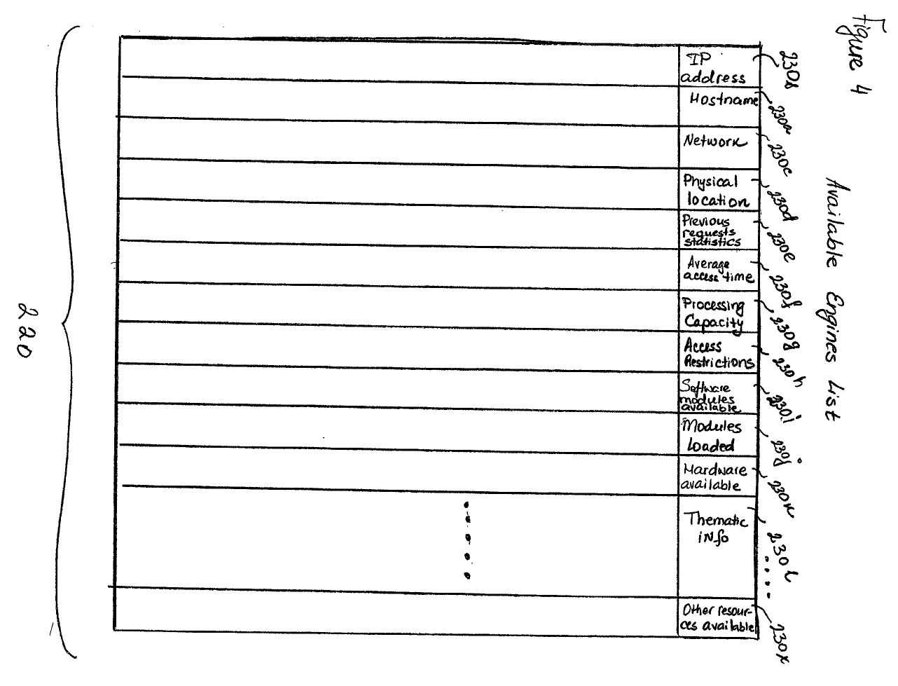

Arbitration module 208 determines the processing entity to process the request using the parsed request and information in available engines list 220. Available engines list 220 stores information about engines registered with request management module 110. Such information may include, for example, internet location of a particular engine, such as, for example, host name 230a, IP address 2306, network information, and other characteristics. Other information, such as, for example, physical location information 230c and information about available resources may be stored in available engines list 220. Available engines list is further described in conjunction with FIG. 4.

Arbitration module 208 may select engines that contain resources requested by the request or that correspond to certain characteristics of the request. For example, if the request is coming from a particular geographic area, arbitration module 208 may pick a processing entity from that geographic area as well. In other embodiments, arbitration module 208 may pick a processing entity that is proximal to the client in terms of internet location instead of (or in addition to) physical location. For example, arbitration module 208 may pick a processing entity that is located in the same domain or on the same subnet as the client. There may be more than one processing entity that corresponds to a particular set of characteristics; or the client may not request any specific characteristic, in which case arbitration module 208 may use any of a number of suitable arbitration schemes known in the art to select the processing entity to process the request. Selecting the processing entity is discussed in further detail in connection with FIG. 6.

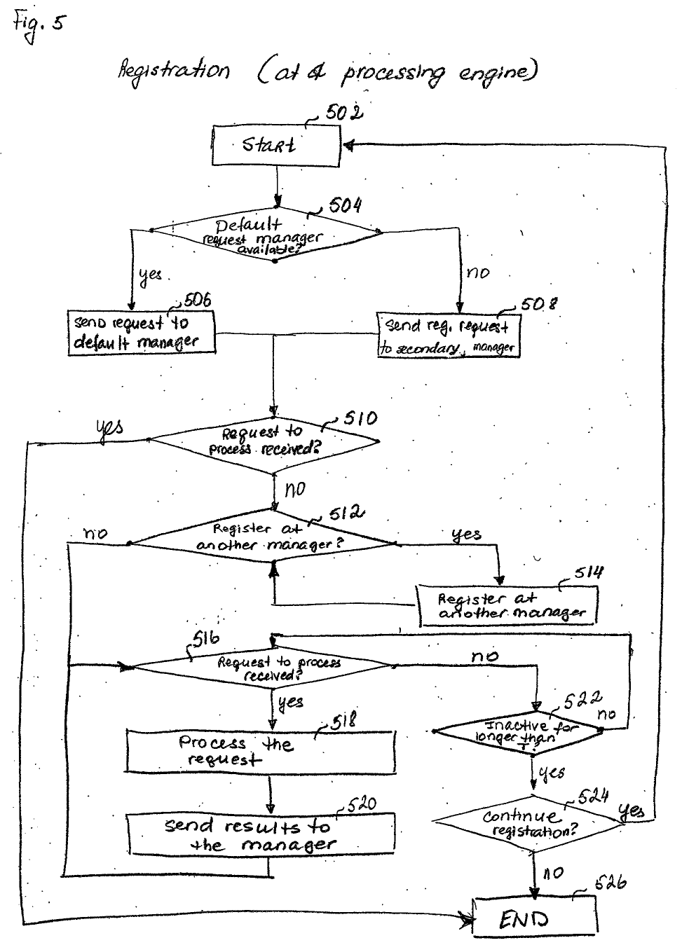

Information may be added to the available engines list through registration handler 210. Registration handler 210 may communicate with processing entities, accepting their registration information. For example, a processing engine may communicate with registration handler 210 to register with request management module 110 or to re-register after a period of inactivity. In the case of a new registration, registration handler 210 may add a new entry to available engines list 220. In the case of re-registration, registration handler 210 may modify an existing entry to update, a time stamp signifying the time of registration. In an alternative embodiment, the registration handler may remove a previous entry and add a new entry during the re-registration process. Furthermore, registration handler 210 may monitor available engines list 220 and periodically remove from it processing entities that have been inactive for longer than a predetermined period of time. In yet another embodiment of the invention, such processing entities may be merely labeled inactive, or be labeled inactive for a period of time and then removed if still inactive after another predetermined period of time. Registration and re-registration is further described in connection with FIGS. 3 and 5.

Request management module 110 may contain additional modules, such as, for example, a statistics module (not shown) for collecting and processing statistics information about the number and kind of requests processed, processing entities registered, number of requests, number of different clients accessing the request management module, etc. Other modules and modifications may be added as deemed appropriate by one skilled in the art.

FIG. 3 is a flow chart illustrating processing engine registration with the request management module. Acts shown in FIG. 3 take place at the request management module. Acts taken at the processing engine are illustrated in FIG. 5.

Variables may be initiated in act 302, which takes place at the time of the initialization of the request management module. For example, available engines list 220 may be loaded into computer memory at that stage. In an alternative embodiment, an available engines list may remain as a file in a file system, an entry in a database, or as a database.

A registration request is received from a processing entity in act 304. Such a registration request may arrive through network 102. The registration request (not shown) may be a standardized request, supplying information about the processing entity. A re-registration request may be of the same format as the registration request. In some embodiments of the invention, a re-registration request may differ from the registration request and may supply less information about the processing engine.

If the processing entity has already registered at the request management module—that is, if this is a re-registration request or re-transmission of the registration request (due to network conditions), as determined in act 306, only certain characteristics of the processing entity may be updated in act 308. Such characteristics may be, for example, a time stamp signifying the time of the registration. Registration statistics may also be updated on re-registration.

If the processing entity has not registered with the request management module before, as signified, for example, by the absence of a corresponding entry in the available engines list 220, a new entry may be created in the available engines list 310. The entry may contain information about the processing entity. The information about the processing entity may come from the original registration request. Registration handler (see FIG. 2) may communicate with the processing entity in order to receive additional information about the processing entity. The additional information may also be stored in the available engines list.

The registration manager may keep checking whether a particular processing entity has been inactive for a predetermined period of time. Such checking may take place in act 312. The period of inactivity may be due to an overall light load of requests, or due to intermittent network problems, or other causes. Typically, a processing entity re-registers with the request manager module after a period of inactivity, so for the majority of active processing entities, the period of inactivity listed should not exceed the predetermined period of inactivity.

Engines that have been inactive for longer than a certain period of time may be removed from the available engines list in act 314. In an alternative embodiment, engines may be marked inactive instead of removing entries associated with those engines.

The registration/updating process completes in act 316. The registration process is not limited to the acts described above, of course. Furthermore, the acts need not be perform in the order shown. The registration process may be modified and augmented as appropriate for a particular embodiment of the invention.

FIG. 4 illustrates available engines list 220. Available engines list 220 may be implemented as a file, an entry in a file system, a database or a subset of the database, an object, a table in memory, or a combination of any of these or other suitable entities. Available engines list 220 may be organized based on various characteristics of the entries stored in it. For example, it may be sorted based on IP addresses of processing entities. In an alternative embodiment of the invention, the available engines list may be organized in the First-In-First-Out (FIFO) fashion. In some embodiments of the invention, the available engines list may be organized in a hierarchical fashion or may be organized into another structure that facilitates efficient access.

In some embodiments of the invention, only available processing entities may be listed in the available engines list. If an entity becomes unavailable, its entry may be removed from the available engines list. Alternatively, all processing entities that have registered with the request management module may be listed in the available engines list. Unavailable processing entities may be merely marked as unavailable. In addition, a reason for unavailability may be recorded.

A processing entity may become unavailable if, for example, it is currently processing a request and it is listed as being capable of processing only one request at a time. Alternatively, a processing entity may become unavailable if it is processing a particularly computationally-intensive request, or if its resources are being used to the maximum by various requests. Such an entity may become available again after it completes processing one or more requests.

Processing entities may be deemed unavailable after a predetermined period of inactivity. The period of inactivity may be uniform—such as, for example, an identical period for all engines, or it may vary from engine to engine or from a group of engines to a group of engines. For example, a group of engines in a particular geographic area may have a longer maximum period of inactivity in order to reduce the total network traffic to those engines. In an alternative embodiment of the invention, the maximum period of inactivity may be adjusted from time to time in order to correspond to the real-life network conditions.

The available engines list may contain fields describing network location and status of the available engines, such as, for example, IP address field 230b, hostname field 230a, network description field 230c, and others. Network description 230c may be a description of the physical state or characteristics of the network—for example, whether a particular engine is located on a gigabit or a megabit network, etc.

The available engines list may also contain fields describing physical location of the engines and information about their processing capacity and availability. For example, average access time field 230f may contain statistical information about previously fulfilled requests and the time it took to fulfill them. The arbitration module (FIG. 2) may use such information to, for example, select the fastest engine to fulfill an urgent request.

Processing capacity field 230g may describe physical characteristics of the engine—such as, for example, hardware on which it is running and its capabilities. Processing capacity field 230g may be also used to keep track of the number and kind of requests that a particular engine is currently processing in order to access the remaining available processing capacity of the engines. Additionally, processing entities may be estimated based on the speed and number of requests previously fulfilled.

Different processing engines may have different access restrictions, as reflected in access restrictions field 230h. For example, certain engines may only receive requests from system administrators. In an alternative embodiment of the invention, there may be different access levels, and different processing engines may allow different access levels, as represented in access restrictions field 230h.

Different processing engines may have different software modules loaded or available to be loaded. Some engines may be able to load modules during processing of the request, while others may be limited to using software modules that have been pre-loaded. Furthermore, different processing engines may have access to different software modules for computations. For example, a group of processing engines may have access to software modules for performing statistical calculations, while other processing engines may not have such capability. Availability and capabilities of the software modules provided on each processing entity may be listed in software modules available field 230i. Modules that have been loaded may be listed in modules loaded field 230j.

Different processing engines may have access to different hardware modules and networks. For example, one group of processing engines may be connected to the telephony network, while another group of processing engines may be connected to the cable modem network. In addition, different processing engines may have different hardware configurations, and thus allow for different processing capabilities. For example, peripheral hardware may be connected to a group of engines, while such peripheral hardware may not be available from other engines. Hardware modules available may be listed in the hardware available field 230k.

Engines may be grouped based on thematic characteristics in order to provide efficient access to a particular group of clients. A thematic characteristic may be any characteristic of an engine relating to the kind of computations that processing engine is adapted to perform. For example, a group of processing engines may be dedicated to processing requests from clients from a particular organization. Information related to this group of clients may be stored in the thematic information field 2301. Various groupings and sub-groupings may be available. Thematic and other information may be modified on the fly in response to real-time, actual system conditions. Furthermore, such information may be modified in anticipation of particular system events or conditions. For example, if it is anticipated that a particular group of clients will send a large number of requests in a particular period of time, a larger number of processing engines may be thematically dedicated to that group of clients in advance in order to anticipate the increase in traffic. In an alternative embodiment of the invention, thematic information may contain other descriptive information for processing engines.

Engine characteristics and fields of the available engines list are not limited to those described herein. The fields may be combined or grouped as deemed appropriate by one skilled in the art. Furthermore, additional engine characteristics may be recorded and kept in the available engines list. Alternatively, processing entities may be ranked and organized based on particular characteristics.

As described above, other request management modules and multiple processing engines may register with a particular request management modules. Those processing entities may also be recorded in the available engines list. With respect to the request management modules, some fields may remain unfilled, because the request management modules may route requests to a number of engines. In some embodiments of the invention, stored in the available engines list may be summaries of total processing capabilities accessible through a particular request management module.

FIG. 5 is a flow chart illustrating processing engine registration as performed by the processing engine. The processing engine may be activated in act 502. Stored in the processing engine settings may be information about a default request manager module that should be accessed. Such a default request manager may be, for example, a centralized request manager modules. It may be identified by a hostname or an IP address or other network characteristics. It must be noted that the default request manager may be distributed over a number of physical or logical computational devices.

A check may be performed in act 504 in order to determined whether the default request manager module is available. Network problems or hardware problems may result in unavailability of the default request manager module. During the default request manager down-time, the processing engine may register with additional request manager modules. These additional request manager modules may provide alternative access points to the clients during the time that would otherwise be a system down-time if there were only one request manager module.

The registration request is sent to the default request manager module in act 506. Alternatively, a registration request is sent to a secondary request manager module in act 508. The secondary request manager module may be determined, for example, from a list of secondary request management modules. In an alternative embodiment of the invention, the secondary request management modules may be discovered through network communications using methods known in the art.

In one embodiment of the invention, the processing engine may not receive any confirmation of the registration. The processing engine may start to receive the requests for processing, as illustrated in act 510. A receipt of the first request for processing may be deemed to be a confirmation of the registration. In an alternative embodiment of the invention, the request management modules may send out confirmations of registration to registered processing engines.

The processing engine may be registered at more than one request management module, as illustrated in acts 512 and 514. In one embodiment of the invention, the number of the additional request management modules at which the processing engine may register may be limited only by the total number of the request management modules. Alternatively, such number may be limited in order to limit the total traffic in the system and a possibility of over-loading of one processing engine with requests sent from different request management modules.

After the processing engine has registered, it may be in a wait mode to receive requests. If no requests have been received for a particular period of time, as determined in acts 516 and 522, it may re-register with the request management modules. If there are software or hardware problems, the processing engine may not need to re-register, as determined in act 524. If the re-registration is required, the processing engine may return to act 502 to start the new registration process. In an alternative embodiment of the invention, the re-registration process may differ from the registration process. In yet another embodiment of the invention, processing the request (act 518) and sending results back to the request manager (act 520) may be treated as re-registration and may be used to update processing engine information in the available engines list.

The process of registration and re-registration allows for dynamic updating of engines in the system. For example, engines may be removed or added to the system in real time, without imposing additional load on the system. If the system is experiencing an unusually high volume of requests, additional engines may be brought online without interrupting performance of the system. Furthermore, if a particular subset of processing entities is experiencing network or hardware problems, it need not affect the performance of the system and other processing entities. In addition, if a particular group of processing entities may get cut-off from the main network, it may perform independently by registering with a local request management module.

FIG. 6 is a flow chart illustrating an exemplary process for determining an engine to process a request. The arbitration module (FIG. 1) may be loaded in act 602. The arbitration module may use information from the request in order to determine the proper processing engine to fulfill the request. For example, if a particular processing engine is requested in the request information, as determined in act 604, and that engine is available (act 606), associated engine information may be updated (act 608) and the request may be forwarded to that processing engine.

Listed in the information in the request may be a particular location from which a processing engine is requested. For example, a client may request a processing engine that within some proximity to the client. The proximity may be physical or internet proximity and may be determined in any number of ways known in the art. Processing entities within that proximity or in a particular location may be selected in act 614.

In addition, listed in the information in the request may be a particular set of resources that are required for fulfilling the request. That set may be ascertained in act 616, and the processing entities possessing those resources may be selected in act 618. By specifying a list of required resources, the client may speed up processing of the request because an appropriate processing engine may be selected. Alternatively, the client may not specify the required resources, and the processing engine may need to request particular computations to be performed on those resources by other processing engines.

Thematic preferences may also be specified in the information in the request, as determined in act 620. Such thematic preferences may list, for example, an organization which the client represents. Processing engines dedicated to that organization may be selected, for example, in act 622. Furthermore, an access control level may be specified in the request, as determined in act 624, and processing entities with appropriate access control levels may be selected in act 626.

Various other characteristics of the requested processing engines may be specified and determined in act 628. Processing engines may be selected based on those characteristics in act 630.

It must be noted that any of the above-listed characteristics may be specified in conjunction with each other or separately. An appropriate set of processing engines these may be selected in correspondence to the requested characteristics. An exact watch or “best fit” criteria may be used for selection.

A particular processing engine may be selected from the appropriate set in act 632. Such selection may be performed based on any number of arbitration schemes or their combinations. For example, a request may have an urgent status and the fastest processing engine may be selected to process that request. In an alternative embodiment of the invention, the processing engine may be selected randomly. In yet another embodiment of the invention, any number of other arbitration schemes may be used, such as, for example “most-recently-accessed,” “round-robin,” etc.

Corresponding processing engine information may be updated in the available engines list in act 608. For example, an engine may be deemed unavailable because it is processing a particular request. The processing entity selection process completes in act 610.

FIG. 7 is a flow chart illustrating an exemplary process for processing a request. A number of the request processing acts have been described above, and they are repeated here only for illustration purposes. The request is sent out from the client in act 704 and is received at the request management module in act 704.

The request may be parsed in act 706 and the processing entity to process the request may be identified in act 708 (FIG. 6). If the identified processing entity is another request processing manager, as determined in act 710, the request may be transferred to that request processing manager in act 712, so that it may perform acts 704-710 in order to further route the request. In an alternative embodiment of the invention, results of parsing the request may also be transferred to the additional request manager module in order to avoid parsing the request again.

The request may be normalized in act 714. Normalization of the request may involve converting the request into a standard form determined for the system. Furthermore, normalization may involve extracting additional request information and packaging it into a different form. For example, request information may initially be contained in a URL submitted through an HTML script. Information may be extracted from such a URL and may be packaged into a standard object that will then be processed by the processing engine.

The normalized request is transferred to the processing engine in act 716. The processing engine may determine in act 718 that it needs to load additional resources in order to process the request. Such resources may be loaded in act 720 and the request may be processed in act 722.

Results of the processing may be transferred back to the request management module in act 724. Results of the processing may be converted to a format requested by the client (act 726). For example, results may be converted from a software object into a string conforming to the HTML protocol. Converted processing results may be transferred back to the client in act 728.

The request processing method is not limited to the acts described herein and may be modified or augmented as deemed appropriate by one skilled in the art. Furthermore, the acts need not be performed in order listed and may be performed on one or more computing entities.

FIG. 8 is a schematic representation of one embodiment of client user interface that may be used by a client. Illustrated is a web page 810 with an HTML form 812 that allows the client to send requests to system 100. Such a request may be, for example, a request to visualize the status of a particular cable modem. URL 814 represents a request that may be sent to the request management module. Certain labels from the URL may be interpreted in parsing as requesting particular characteristics from a processing engine. For example, the INSTANCE field 816 may be used to encode the type of the form being used and, correspondingly, type of resources that may be needed to process this request. In an alternative embodiment of the invention, this request may be represented in another form and may include, for example, additional requested characteristics of the processing engine.

Computer systems may be adapted for implementing various elements of system 100 through appropriate computer programs. Such computer system typically include a main unit connected to both an output device which displays information to a user and an input device which receives input from a user. The main unit generally includes a processor connected to a memory system via an interconnection mechanism such as a bus. The input device and output device also are connected to the processor and memory system via the interconnection mechanism.

It should be understood that one or more output devices may be connected to any such computer system. Example output devices include a cathode ray tube (CRT) display, liquid crystal displays (LCD), printers, communication devices such as a modem, and audio output. It should also be understood that one or more input devices may be connected to the computer system. Example input devices include a keyboard, keypad, track ball, mouse, pen and tablet, communication device, and data input devices such as sensors. It should be understood the invention is not limited to the particular input or output devices used in combination with the computer system or to those described herein.

The computer system may be a general purpose computer system which is programmable using a computer programming language, such as C++, Java, or other language, such as a scripting language or assembly language. The computer system may also include specially programmed, special purpose hardware. In a general purpose computer system, the processor is typically a commercially available processor, of which the series x86 and Pentium processors, available from Intel, and similar devices from AMD and Cyrix, the 680X0 series microprocessors available from Motorola, the PowerPC microprocessor from IBM and the Alpha-series processors from Compaq Computer Corporation, are examples. Many other processors are available. Such a microprocessor executes a program called an operating system, of which WindowsNT, UNIX, DOS, VMS and OS8 are examples, which controls the execution of other computer programs and provides scheduling, debugging, input/output control, accounting, compilation, storage assignment, data management and memory management, and communication control and related services. The processor and operating system define a computer platform for which application programs in high-level programming languages are written.

A memory system typically includes a computer readable and writeable nonvolatile recording medium, of which a magnetic disk, a flash memory and tape are examples. The disk may be removable, known as a floppy disk, or permanent, known as a hard drive. A disk has a number of tracks in which signals are stored, typically in binary form, i.e., a form interpreted as a sequence of one and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and then copies the data to the disk when processing is completed. A variety of mechanisms are known for managing data movement between the disk and the integrated circuit memory element, and the invention is not limited thereto. It should also be understood that the invention is not limited to a particular memory system.

It should be understood the invention is not limited to a particular computer platform, particular processor, or particular high-level programming language. Additionally, the computer system may be a multiprocessor computer system or may include multiple computers connected over a computer network. It should be understood that each module (e.g. request management module 120) may be separate modules of a computer program, or may be separate computer programs. Such modules may be operable on separate computers. Data (e.g. available engines list 220) may be stored in a memory system or transmitted between computer systems. The invention is not limited to any particular implementation using software or hardware or firmware, or any combination thereof. The various elements of the system, either individually or in combination, may be implemented as a computer program product tangibly embodied in a machine-readable storage device for execution by a computer processor. Various acts of the process may be performed by a computer processor executing a program tangibly embodied on a computer-readable medium to perform functions by operating on input and generating output. Computer programming languages suitable for implementing such a system include procedural programming languages, object-oriented programming languages, and combinations of the two.

Having now described several embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

Some aspects of the foregoing embodiments have been implemented and may be observed in Auspice Visibility Interface Adapter (VIA) for TLX Engines. Implementation details may be found in VIA documentation. This documentation includes: Auspice TLX™ Visibility Inter-face Adapter (VIA) User's Guide—Release 1.0 Draft; Visualization Interface Adapter Supplemental Capability document, and Visibility Interface Adapter (VIA) Requirements document. All VIA and related documentation is expressly incorporated herein by reference.

All publications cited herein are hereby expressly incorporated by reference.

What is claimed is:

1. In a distributed client-server architecture, a method for processing, on a processing entity, at least one request from a client, said method comprising:
registering at least one available processing engine at a request management module;
receiving the at least one request at the request management module;
determining, at the request management module, a processing engine from available processing engines based on information in the at least one request;
transferring the at least one request to the determined processing engine;
processing the request at the determined processing engine;
transferring results of processing the request to the request management module; and
transferring the results of processing the request from the request management module to the client.

2. The method of claim 1, further comprising updating information about said processing engines, and wherein the act of registering the a least one available processing engine at the request management module further comprises recording the information about said available processing engines.

3. The method of claim 2, wherein the information about the available processing engines comprises at least one of: internet location information, physical location information, previously processed requests information, previous registration information, and access time information; and wherein determining said processing engine further comprises determining a processing engine for which said processing engine information contains at least a subset of characteristics corresponding to the information in the request.

4. The method of claim 2, wherein the information about the available processing engines comprises at least one of: processing capacity information, access control information, loaded software processing resources information, available hardware resources information, and thematic engine information; and wherein determining said processing engine further comprises determining a processing engine for which processing engine information contains at least a subset of characteristics corresponding to the information in the request.

5. The computer-implemented method of claim 2, wherein the act of determining the processing engine further comprises determining the processing engine based on the information about the available processing engines.

6. The computer-implemented method of claim 5, further comprising determining a subset of the available processing engines for which processing engine information contains at least a subset of characteristics contained in the information in the request, and wherein the act of determining the processing engine further comprises using an arbitration scheme to determine said processing engine from the subset of the available processing engines.

7. The computer-implemented method of claim 6, wherein the arbitration scheme is a priority-based scheme in which a priority is determined based on processing engine information and the characteristics contained in the information in the request.

8. The computer-implemented method of claim 3, wherein the act of determining the processing engine further comprises determining the processing engine based on at least one of: proximity between a client originating the request and the processing engine, and proximity between a location identified in the request and the processing engine.

9. The computer-implemented method of claim 8, wherein the proximity is at least one of: geographical proximity, and internet proximity.

10. The computer-implemented method of claim 4, wherein the act of determining the processing engine further comprises determining a nearest match based on at least a subset of the characteristics contained in the information in the request and at least a portion of the information about available processing engines.

11. The computer-implemented method of claim 4, wherein the act of determining the processing engine further comprises determining the processing engine for which available hardware resources information contains at least a portion of a hardware requirement list from the information in the request.

12. The computer-implemented method of claim 4, wherein the act of determining the processing engine further comprises determining the processing engine for which available software resources information contains at least a portion of a hardware requirement list from the information in the request.

13. The computer-implemented method of claim 1, wherein the determined processing engine is a combination of at least two engines.

14. The computer-implemented method of claim 1, wherein the determined processing engine is a second request management module.

15. The computer-implemented method of claim 14, further comprising performing the acts of registering, receiving, determining, and transferring at the second request management module.

16. The computer-implemented method of claim 1, further comprising constructing a hierarchy of request management modules, wherein at least one request management module is registered as an available processing engine for at least one other request management module.

17. The computer-implemented method of claim 16, wherein the information about the at least one available engine further comprises information identifying each of the available engines as at least one of a request management module and an engine.

18. The computer-implemented method of claim 1, further comprising selecting, at the at least one processing entity, the request management module from at least two request management modules.

19. The computer-implemented method of claim 18, wherein one request management module from the at least two request management modules is a default request management module, and wherein the act of selecting the request management module further comprises determining that the default request management module is not available and registering with at least one other request module from the at least two request management modules.

20. The computer-implemented method of claim 18, wherein the act of registering at the request management module further comprises registering with two or more request management modules from the at least two available request management modules.

21. The computer-implemented method of claim 1, wherein the act of transferring the request further comprises normalizing information in the request.

22. The computer-implemented method of claim 21, wherein the act of normalizing the information in the request further comprises packaging at least a subset of the information in the request into at least one object.

23. The computer-implemented method of claim 21, wherein the act of receiving the information is performed using a first protocol, and wherein the act of transferring the request is performed using a second protocol.

24. The computer-implemented method of claim 23, wherein the act of normalizing the information in the request further comprises converting the request from a presentation in the first protocol to a presentation in the second protocol.

25. The computer-implemented method of claim 1, further comprising re-registering the at least one available processing engine after a period of inactivity.

26. The computer-implemented method of claim 25, wherein the act of registering the at least one available processing engine further comprises removing the at least one available processing engine from a list of available processing engines after a second period of inactivity.

27. The computer-implemented method of claim 1, wherein transferring the request from the request management module further comprises normalizing the request.

28. The computer-implemented method of claim 27, wherein transferring the results of processing the request to the request management module further comprises converting the results to a form acceptable by the client.

29. The computer-implemented method of claim 28, wherein transferring the results from the request management module to the client is performed on a first protocol and wherein transferring the results from the processing engine to the request management module is performed on a second protocol, and wherein converting the results further comprises converting the results from the second protocol to the first protocol.

30. The computer-implemented method of claim 1, wherein transferring the request to the processing engine further comprises keeping a open connection between the request processing module and the determined processing engine open.

31. A computer-implemented system for selecting one of a plurality of processing engines for processing a request from a client, said system comprising:
the plurality of processing engines; one or more of which may be available for processing a request when a request is received.
an engine registration module which registers processing engines and their availability from the plurality of processing engines; and
a request management module which selects a processing engine from the available processing engines based on information in the request and information about the available engines.

32. The computer-implemented system of claim 31, wherein the information about the processing engines comprises at least one of: internet location information, physical location information, previously processed requests information, previous registration information, and access time information.

33. The computer-implemented system of claim 31, wherein the information about the processing engines comprises at least one of: processing capacity information, access control information, loaded software processing resources information, available hardware resources information, and thematic engine information.

34. The computer-implemented system of claim 30, wherein the information in the request comprises at least one parameter for determining the processing engine from the available processing engines.

35. The computer-implemented system of claim 34, wherein the at least one parameter is a combination of at least one of: a physical location, an internet location, previously processed requests information, and access time information.

36. The computer-implemented system of claim 34, wherein the at least one parameter is a combination of at least one of: access control information, software processing resources information, available hardware resources information, and thematic information.

37. The computer-implemented system of claim 30, wherein the processing engine is a combination of at least two processing engines.

38. The computer-implemented system of claim 30, further comprising a second request processing module registered at the registration module.

39. A software product including a machine readable medium on which is provided a signal or signals representing one or more sequences of instructions which, when executed by an appropriate computer, direct a computer to perform a method for processing, on a processing engine, at least one request from a client, said method comprising:
registering at least one available processing engine at a request management module;
receiving the at least one request at the request management module;
determining, at the request management module, a processing engine from available processing engines based on information in the at least one request;
transferring the at least one request to the determined processing engine;
processing the request at the determined processing engine;
transferring results of processing the request to the request management module; and
transferring, from the request management module, the results of processing the request to the client.

40. The software product of claim 39, wherein instructions for registering at least one available processing engine further comprise instructions for recording information about the at least one available processing engine.

41. The software product of claim 40, wherein the information about the at least one processing engine comprises at least one of: internet location information, physical location information, previously processed requests information, previous registration information, and access time information.

42. The software product of claim 40, wherein the information about the at least one available processing engine comprises at least one of: processing capacity information, access control information, loaded software processing resources information, available hardware resources, and thematic engine information.

43. The software product of claim 40, wherein instructions for determining the processing engine further comprise instructions for determining nearest match based on at least a portion of the information in the request and at least a portion of the information about the at least one available processing engine.

44. The software product of claim 43, wherein the instructions for determining the processing engine further comprise instructions for determining the processing engine for which available hardware resources information contains at least a portion of a hardware requirement list from the information in the request.

45. The processing entity, for use in a client-server computer system receiving requests from clients at a request management module and forwarding the requests to processing entities, said processing entity comprising a registration module for registering with the request management module and re-registering after a period of inactivity; and a processing module for processing the requests.

46. The processing entity of claim 44, further comprising a loading module for loading additional software modules during request processing.

47. The processing entity of claim 44, further comprising interface modules for communication on at least two networks.
